(19) United States
(12) Patent Application Publication
(10) Pub. No.: US 2006/0083660 A1
(43) Pub. Date: Apr. 20, 2006

(54) Modular apparatus

(75) Inventors: Reto Schorno, Adligenswil (CH); Willi Bucher, Hausen a. Albis (CH); Peter Vischer, Kuessnacht am Rigi (CH)

Correspondence Address: ROCHE MOLECULAR SYSTEMS INC;PATENT LAW DEPARTMENT, 1145 ATLANTIC AVENUE, ALAMEDA, CA, 94501, US

(73) Assignee: ROCHE MOLECULAR SYSTEMS, INC., Alameda, CA (US)

(21) Appl. No.: 11/073,223

(22) Filed: Mar. 3, 2005

(30) Foreign Application Priority Data
Mar. 31, 2004 (EP) 04007764.6

(51) Int. Cl. G01N 35/00

(52) U.S. Cl. 422/63

(57) ABSTRACT

A new apparatus is disclosed that can be assembled quickly and reliably. The apparatus contains a transfer module, at least two support modules firmly connected to said transfer module and at least two carrier elements firmly connected to said transfer module and bearing said transfer module. The apparatus is particularly useful for performing multistep analytical processes that require precise access of tools of a transfer tool to items on a working area.

### FIELD OF THE INVENTION

The present invention is directed to a method for manufacturing an apparatus for conducting a multi-step analytical process comprising a transfer module, support modules and carrier elements, as well as the modular analytical apparatus and a collection of modules for manufacturing such analytical apparatus. The invention can be used particularly advantageous in the field of analytics, for example in health care.

### DESCRIPTION OF RELATED ART

Apparatus for conducting multi-step analytical processes have been known. In EP 1 032 839 there is disclosed an instrument providing handling units for different handling steps on a joint working area. However, future laboratories will have a need to employ high throughput instruments, i.e. instruments which can handle analysis of many samples in parallel. A further instrument is disclosed in EP 990 906. That discloses an apparatus for conducting a multi-step analytical process comprising a first apparatus for isolating nucleic acids from a sample, and a second apparatus for amplifying and determining those nucleic acids. Those apparatus are linked by a transport module which carries the purified nucleic acids from an output position of the first apparatus to an input position of the second apparatus. As the functions of those two apparatuses are substantially different, the linking module is used to bring the samples from the first level to the second level.

In very large laboratories frequently there is a multiplicity of apparatus which have the same purpose, for instance for clinical chemistry detection, that are linked to a common distribution unit. In such a construction, there are transport units that lead from the distribution unit to each single detection unit. These modules are working autonomous and there is no joint transport unit for functional linkage of the instruments in series.

In clinical laboratories, the ground surface generally may not be very planar. The surface may have elevations and depressions and in many cases it will be difficult to find a common plane such that the different modules fit together such that the samples can be carried safely from one apparatus to the other.

Therefore, there was a particular need for instruments, which allow high throughput analyses in multi-step processes, which can be easily and reliably assembled at the place of the future use.

### SUMMARY OF THE INVENTION

This object is solved by the present invention.

The first subject of this invention is a modular apparatus for conducting a multi-step analytical process comprising
a transfer module,
at least two support modules firmly connected to said transfer module and
at least two carrier elements firmly connected to said transfer module and bearing said transfer module,
   wherein said support modules and said transfer module comprise corresponding integral engagement elements to exactly position said support modules in relation to said transfer module.

Another subject of the invention is a modular apparatus for conducting a multi-step analytical process comprising
a transfer module,
at least two support modules firmly connected to said transfer module and
at least two carrier elements firmly connected to said transfer module and bearing said transfer module,
   wherein said support modules are connected to the transfer module from underneath.

Still another subject of the invention is a modular apparatus for conducting a multi-step analytical process comprising
a transfer module,
at least two support modules firmly fixed to said transfer module and
at least two carrier elements firmly connected to said transfer module and bearing said transfer module,
   wherein said transfer module is supported by said carrier elements at either 3 or 4 carrier spots.

Another subject of the invention is a method for assembling an analytical apparatus for an analytical process comprising
a transfer module,
at least two support modules firmly connected to said transfer module and
at least two carrier elements,
   comprising the steps
providing at least two support modules releasably fixed to said carrier elements,
providing said transfer module and placing it onto said carrier elements,
firmly connecting said support modules to said transfer module.

Still another subject of the invention is a collection of modules for assembling an analytical apparatus comprising
a transfer module,
at least two carrier elements having connecting means to connect said carrier elements to said transfer module and
at least two support modules releasably fixed to said carrier elements, said support modules and said transfer module having integral engagement elements to exactly position said support modules in relation to said transfer module.

Another subject of the invention is a collection of modules for manufacturing an analytical apparatus for an analytical process comprising
a transfer module,
at least two carrier elements having connecting means to connect said carrier elements to said transfer module and
   at least two support modules releasably fixed to said carrier elements, wherein said support modules are provided on compressible supports on said carrier elements.

One possible advantage of present invention is that it eases multistep analyses. Another possible advantage is that the apparatus according to the present invention can more reliably be assembled at the place of final destination, even by persons having a lower degree of technical skills. Any unevenness of the ground can be balanced easier. The invention further provides an apparatus the components of which can be transported to the final destination even through doors. The modular construction makes possible fully automated instruments, not requiring manual intervention during the process of determination of an analyte in a sample in a multistep analysis.

### BRIEF DESCRIPTION OF THE FIGURES

In FIG. 1, three carrier elements (A, B, C) and three support modules are schematically shown.

In FIG. 2 a to 2 g, an exemplary process for assembly of three support modules (10, 20, 30) on carrier elements (A, B, C), a transfer module (40) and a cover module (55) is shown.

FIG. 3 shows an exemplary transfer module in relation to the working areas.

### DETAILED DESCRIPTION OF THE INVENTION

In the following, an apparatus is considered to be modular, if it contains two or more constructional elements that are used in assembling the apparatus. These elements are called modules in the following. The modules may or may not be elements having a particular function in the use of the apparatus. Preferably, the modules comprise functional tools, for instance for conducting particular operations in a multistep procedure. The modules can be autonomous or non-autonomous. The functions of the modules can be the same or can be different. The modules can be linked together directly or be independently constructed. Each module can contain tools to perform different operations, including mechanical or optical actions. Furthermore, the modules can require interfering with each other during their actions. Preferably, the modules have functions that are applied in a process in series, preferably in order to process one or more samples in an analytical process. Exemplary modules are selected from the group of transfer modules, support elements and carrier modules.

A multi-step process is a process having two or more steps. Those steps can be performed in parallel or in series. In the first case, a number of steps, same or different, are started at the same time. This is called the parallel mode. In the second case, the steps are performed in series each at a different starting time. This is called the serial mode. In the preferred case, each series of steps is initiated at a different starting time. A very advantageous use of the present invention is found when serial and parallel mode of conducting steps are mixed. This is when performing several processes in parallel, each being composed of a series of subsequently performed steps. Those series of steps can be started at the same time or subsequently. Most preferred multi-step processes involve conducting the multi-step procedure in parallel batches, for instance four series of processes are started at the same time, in parallel. After this first batch has undergone the first step and proceeds to the second step, the second batch of parallel processes is started.

Analytical processes often require multiple steps during analysis of a sample. Therefore, analytical processes are the particular focus of use of the apparatus of the present invention. An example of such method is the analysis of a sample for a component, i.e. a chemical entity, contained in the sample. Samples containing a large number of different components of interest are samples of natural origin. The samples can be solid or liquid. Examples of particular interest are body fluids or liquids derived therefrom. A particularly preferred liquid is blood or its derivatives, like serum or plasma. Further preferred liquids are urine and sputum. A solid sample is swab and tissue.

Analytical processes derive a result from analysis of a sample. Thus, the starting point of the analysis is a given amount of sample. The result mostly is provided as an electronic signal, shown on a display, for instance on a computer screen. While some analyses do not require chemical or mechanical treatment of the sample, most analyses include several steps of treating the sample, including releasing the components to be detected from their micro-environment in the sample, for example release of the component of interest from cells they are associated with. Some analyses also require enrichment of the component of interest to be detected. In another advantageous mode, preferred when other components of the sample interfere with the analysis, the component of interest is isolated and purified from the original sample and thereafter subjected to detection. Some steps of the procedure, like washing to remove impurities, may be repeated once or more times for a better result. The result of the analysis typically is information given to the person doing the analysis, i.e. on a display, showing the fact of presence or the amount present of one or more components of the sample.

Typical analytical processes are clinical, immunological and molecular diagnostic analyses. Each of them requires multiple operational steps. Those steps are preferably selected from the group of adding or removing liquids or solids to the sample or any subsequently produced solids and liquids. Advantageously, those different steps for a number of reasons are done at different locations on the instrument. Those steps may therefore necessitate the transport of the sample or any derivatives thereof from one location to another on the instrument. In view of the fact that it is beneficial to do similar steps at one site and transport the sample as soon as new tools are needed, the steps are grouped together. In immunology, the procedure may comprise sample preparation, separation and detection. In nucleic acid analysis, the steps are preferably selected from the group consisting of sample preparation, amplification and detection. Each of these steps may be composed of complex procedures.

Steps typically used in analyses are selected from the group of aspirating a sample or/and reagents, dispensing a sample or/and reagents, mixing the sample or/and reagents, heating samples or/and reagents, picking up or/and releasing disposables or and sample containers, discharging liquids or/and solids, irradiating items, detecting electromagnetic radiation and moving items.

The modular apparatus of the invention preferably has a length of between 1.0 and 5 meters, more preferably between 2 and 4 meters, and most preferably between 2.5 and 3.5 meters and a weight of between 80 and 2000 kg, preferably between 150 and 1200 kg. Preferably, the apparatus has a width of at least 0.5 meters, preferably between 0.8 and 1.5 meters and a height of at least 0.8 meters, preferably between 1.0 and 2.5 meters. Typically, the apparatus of the invention has a power supply. Furthermore, it preferably contains storage of all consumables needed for the analysis to be performed in the multistep analysis and one or more waste containers for trash.

The transfer module of the present invention is a part of the apparatus which is designed to transfer items from one position on the apparatus to another position on the apparatus. Preferably, said transfer module comprises a mechanical transfer unit moving from a first of said support modules to a second of said support modules. Items to be transferred include solids, liquids and disposables. Therefore, the transfer module preferably contains a mechanical transfer unit for transporting items from a first support module to a second support module. The functions of the transfer module, and the tools contained within the transfer module, are selected from receiving, maintaining, moving and releasing items.

Preferred liquids are samples to be analyzed, liquids derived from the sample, liquids that contain the analyte to be determined during the process, or suspensions of solids, including solids to which said analyte has been bound. Those liquids are preferably contained within disposables, for instance vessels or pipette tips. Disposables include vessels, pipette tips, caps or reagent bottles. Vessels and pipette tips are known to be useful tools for handling liquids, for example in pipetting apparatus. Both, vessels and pipette tips can be used to transport, to maintain or to mix liquids. Vessels are containers for maintaining liquids or solids, and are usually made of plastics. Pipette tips are devices having at least two openings, one to enter a liquid, and another to withdraw fluid from the device, such that the liquid is drawn into the device by applying a vacuum. By lowering the vacuum in the device, liquid is released from the device. Pipette tips are used in the form of disposable plastics, particularly if the liquid to be aspirated and dispensed should not contaminate samples treated subsequently using the same apparatus. Preferentially, after usage, pipette tips are discarded by releasing them from the socket through which they were attached to the vacuum pumping device. For handling reagents from a reagent container, reusable pipettes or needles can be used. Those pipettes are preferentially made from metal and may be washed with a washing liquid prior to subsequent use with other reagents. Pipetting apparatus are generally known in the art. Usually they contain a pump to apply a vacuum in a controlled manner.

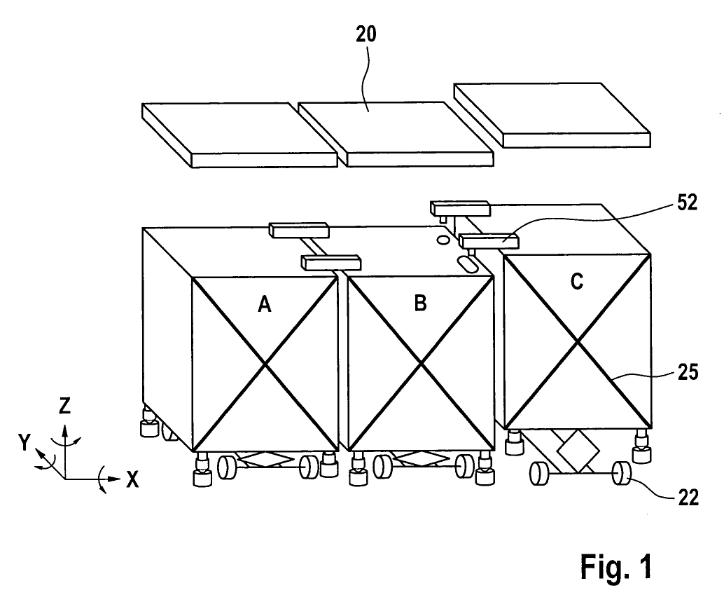

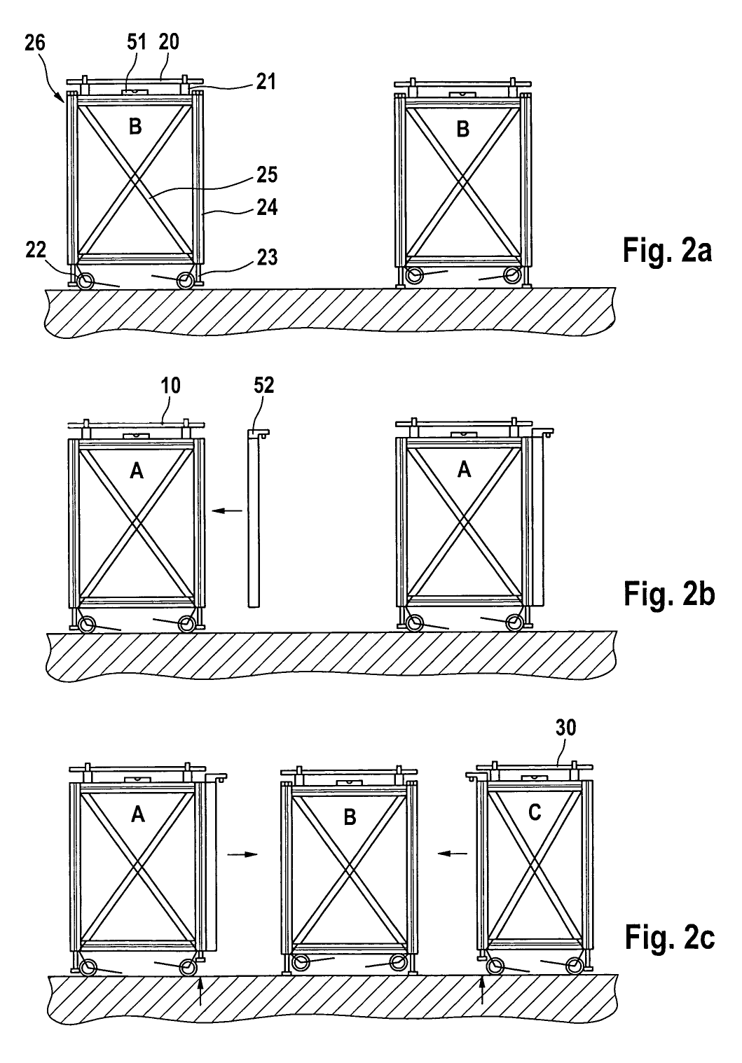

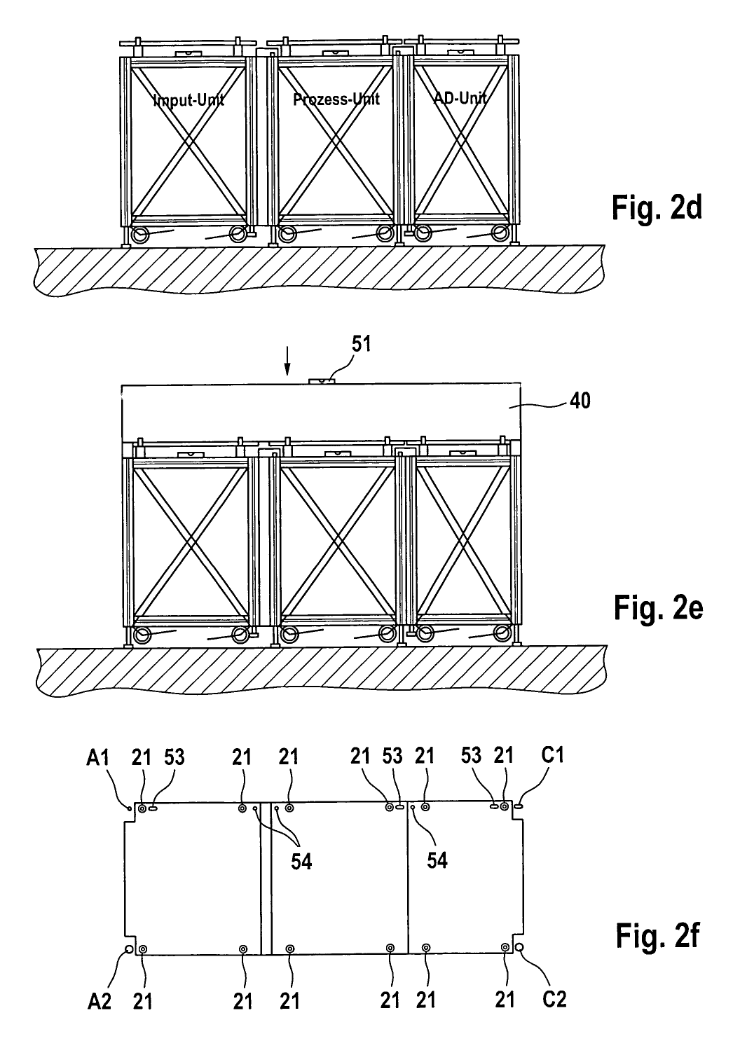

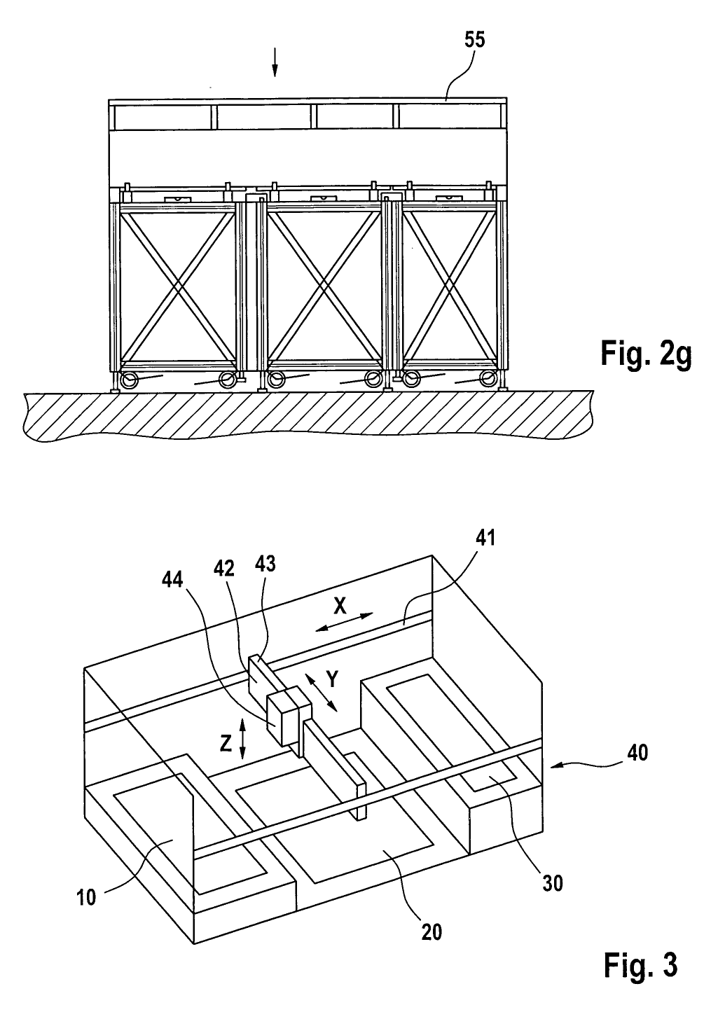

The transfer can be made in any manner, generally by receiving, moving and releasing the item to be transferred. Preferably, the transfer module (40) contains one or more rails (41), on which one or more transfer arms (42) are mounted for horizontal (X) movement of the arm, providing access to one or more support modules. The transfer arm (42) bears at least one transfer head (44) for the transfer of items to be transported within a module and/or from a first module to a second module. Therefore, the transfer head can contain different handling units, for example one or more gripper or socket that are preferably moveable independently in Z-direction. Those transfer heads may include a needle for aspirating/dispensing of fluid, a socket for attaching a disposable pipette tip and/or a gripper for picking up vessels or other disposables or devices. The transfer heads can be moved in any appropriate manner; for instance, they can be driven by a belt drive connected to an electric engine. The transfer can include all three dimensions, X (horizontal, length), Y (horizontal, width) and Z (vertical, height), see FIG. 3.

In a preferred embodiment, the transfer module comprises at least two transfer arms, each having a gripper for picking up and transferring a vessel and a socket for attaching a pipette tip. These transfer arms are designed to be moveable along a common rail (41), the movement paths of the transfer arms allowing an overlap. This overlap is advantageous in order to operate the instrument such that a series of handling steps can be performed subsequently during the analytical process. For instance, the apparatus according to the present invention can with a first transfer head aspirate an aliquot of a liquid from a first vessel, located in an area to which only the first transfer head has access, transport that aliquot to a location to which the second transfer head has access and dispense that liquid into a vessel at that location. At that location, any desired reagents can be added. Thereafter, the resulting liquid can either be aspirated using a pipette tip attached to a socket on the second transfer head or the vessel containing the liquid can be grabbed using the gripper of the second transfer head and the vessel will be transported to any desired location to which the second transfer head has access. In this way, the transfer heads can work at different stages of the analytical process, involving operations on different support modules, thus enhancing the throughput of the apparatus.

In the present invention, there are preferably three transfer arms mounted on a common transfer rail, each of the transfer arms having an overlap in its movement paths with at least one of the other transfer arm. Each transfer arm contains at least one transfer head. The present invention provides the advantage that all handling units for transporting items from one functional unit (module) of the apparatus to another functional unit are contained in the transfer module and therefore do not need adjustment of their relative movement paths at the time the apparatus is finally assembled.

The transfer module comprises means for firmly connecting said transfer module to at least two support modules and to at least two carrier elements. Those means will be disclosed in detail when describing the support module and the carrier element.

A support module according to the present invention is a part of the apparatus which comprises tools adapted to keep the items to be subject to analysis and any means needed for the analysis, preferably providing containers for an analytical process. Preferably, a support module has positions for input and output of items, like liquids and disposables. The support module can be accessed by tools on the transfer module, like transfer heads. Preferably, it is itself not designed to actively interact with other support modules. A support module further comprises a working area on which the sample to be analyzed or liquids derived therefrom is handled. This working area preferably contains means for containing vessels for containing the sample and/or the liquids derived therefrom. Suitable means are containers having a form for safely receiving vessels or other disposables at predefined positions which are accessible to the transfer head, also called racks. Furthermore, it can contain reagents to be used in the analytical process, which may also be contained in containers. Racks may be moveable between different stations on the same or different support modules, transferred by tools of the transfer module or independently.

Each support module is adapted to be connected to the transfer module. This involves constructional means to position the support module at a precisely defined position in all spacial dimensions (X, Y, and Z) versus the transfer module. Such means may include guides, nut and pins. Their geometry, shape or form is chosen to be complementary to its counterpart on the transfer module. Preferably, the support module and the transfer module comprise corresponding integral engagement elements. In this respect, integral means that the engagement element is a part of the support module or of the transfer module. Engagement means that the element fits into a corresponding element on the other module, respectively. Examples of such integral engagement elements are pins, holes, recesses and projections or protrusions. The integral engagement elements preferably are pins. The counterparts of pins on the transfer module are holes and long holes. The bearing of the transfer is designed according to a tetrahedron-vee-flat coupling (see Precision Engeneering 25 (2001)114-127). It will be understood, that the counterparts on the transfer module and the support module can be used vice versa. They may have a shape that allows guiding the support module into the final position versus the transfer module. This can be achieved by inclined surfaces on the elements.

In a preferred embodiment of the present invention, a first support module (10) is designed to accommodate the samples to be analyzed and bring it into a form ready to be analyzed. Such module will in the following be called “sample receiving module”. Preferably, it contains an area for accommodating reagents, which is called “reagent input area”, an area for input of samples to be analyzed, called “sample input area” and an area containing disposables called “disposable input area”. Furthermore, the module comprises an area which is accessible to the transfer head. This area is called “working area”. Reagents, samples and disposables are provided in the sample receiving module manifold. Particularly, there is sufficient supply of disposables to receive the intended number of aliquots of samples to be analyzed, including controls. Generally, samples and controls are provided in primary containers in an amount sufficient to allow as many analyses as intended. In this module, the mechanical and chemical means for inserting the reagents, keeping the reagents in a defined status, if desired, i.e. at the desired temperature, or keeping any solid particles in a liquid in suspension, inserting containers, for instance racks, containing the samples to be analyzed, storing the required number of disposable vessels and pipette tips, and displaying the items to be handled on the working area are provided. In an exemplary process conducted on the sample receiving module, reagents, samples and disposables are introduced into the module at defined positions. In a first step, a disposable reaction vessel is transported from the disposable storage area to a working position on the working area. This can be done by any means, for example a mechanical elevator for transporting the disposable vessel from the storage to the working area. In a first handling step, an aliquot of the sample is added to the vessel at said working position. If needed or desired, any reagents can be added to the disposable vessel either before, concomitantly therewith or subsequently thereto. The handling steps, i.e. aspirating and dispensing of the fluids, according to the present invention are made by a transfer head mounted to the transfer module as described above.

A second preferred support module is designed to isolate components of the sample from the remaining liquid and any reagents, preferably for separating an analyte from a sample contained in a container, i.e. a vessel. Such module will in the following be called “sample preparation module”. This module also displays a working area, which is accessible to a transfer head of the transfer module position, on which said handling steps are to be performed. Furthermore, this module may have reagent input areas. In a typical and preferred embodiment, a liquid will be entered into the sample preparation module by transferring a vessel containing said fluid from an output position on the sample receiving module into the sample input position of the sample preparation module or by dispensing said fluid into a vessel located at said sample input position. Possible handling steps on the sample preparation module include maintaining the fluid at a particular temperature, for example, for releasing any components to be analyzed from cellular components of the sample, adding reagents to the fluid, mixing the fluid with reagents under conditions for binding the component to the solid, separating any solid components of the fluid from the remaining liquid or vice versa, washing any solids to which components of the sample have been bound, detaching components from solids to which they were bound and removing parts or all of the fluid contained in a vessel. Such steps can be performed in any order and repeatedly, if desired, to isolate the components from the liquid. In the preferred case, the result of the process performed on the sample preparation module is a liquid containing the analyte or a compound derived from said analyte or a compound indicative of the presence of said analyte in the sample. This fluid is preferably contained in a vessel located in a sample output position of said sample preparation module.

In a very preferred embodiment, the sample preparation module is designed for isolation of nucleic acids from a sample using binding and detaching the nucleic acids to a solid. In this case, the fluid as received from the sample receiving module contains reagents for lysing cells, i.e. viruses, and magnetic glass particles as well as reagents assisting in binding of nucleic acids to glass surfaces, i.e. chaotropic salts. The vessel containing this mixture is transferred from the sample receiving unit using a first transfer head which is positioned to handle the original sample, the necessary reagents and the disposables to the sample input position on the sample preparation module. The sample input position is kept at elevated temperature, preferably at 37° C. to allow lysis of the cellular components. Then, the mixture is aspirated by a pipette tip mounted on a second transfer head and dispensed into a vessel being kept at another temperature, i.e. 80° C., at a separation position. In this position, the magnetic glass particles are maintained by magnets within the vessel, while the supernatant containing other components of the sample and the reagents can be aspirated and discarded by a second transfer head. In this position, the magnetic particles retained in the vessel are washed, while the nucleic acids are retained bound on the magnetic particles. Any wash fluid is discarded by aspirating and dispensing using the transfer head. In the last step, reagents are added to the magnetic beads in the vessel to which the nucleic acids are bound, to detach the nucleic acid from the magnetic particles. The solution containing the purified nucleic acids is separated from the magnetic particles by aspiration into a pipette tip and dispensing into a fresh vessel which is located at a designated output location.

Reagents that are advantageously and preferably stored at the sample preparation module are washing liquid and elution reagent, most preferably already containing reagents for subsequent amplification and/or detection of the components, i.e. the nucleic acids.

A third preferred support module in this embodiment may be a detection module. Such module contains tools for determining electromagnetic signals from a liquid. In a specific embodiment of an apparatus for detecting nucleic acids, the third module is a combined amplification and detection module. The transfer of the liquid from an output position of the sample preparation module to an input position on the amplification detection module may be done by a transfer head on a third transfer arm, which has an overlapping movement path with the second transfer arm.

This module may be subdivided into two modules, for example if amplification and detection are to be performed in subsequent steps. In the preferred case, in which amplification and detection are done in a so-called homogenous manner, in which no reagents need to be added between the amplification and detection step, one module is sufficient.

In a preferred embodiment, the amplification detection module contains at least one thermocycling position per liquid to be heated in one run. Thermocycles are used to bring a mixture of nucleic acids and amplification reactions to temperatures in a cyclic manner, such that the nucleic acids or parts thereof are amplified. The particularly preferred method for doing such amplification is the Polymerase Chain Reaction, as disclosed in EP 200 362 and EP 201 184. Thermocycling is preferentially done in a computer controlled manner. Therefore, the amplification detection module further comprises computer means to control the temperature adjustment process. Such apparatus is disclosed in EP 236069.

The amplification detection module may further contain containers for receiving liquid and solid waste.

Any detection module or the amplification detection module will further contain means to determine or monitor any properties of the fluid which are dependent upon the presence or the amount of analyte present in the original sample. Preferably, detection modules contain photometer or fluorometer detection instruments. In order to determine the photometric or fluorometric properties of the liquid, the liquid may either be subjected to the detection during amplification, even when the liquid is still in the position used for amplification, or may be transferred to a position in the detection module which is equipped with appropriate detection means, for example light irradiating and light receiving units. Such amplification detection module is disclosed in EP 953379.

A carrier element (A, B and C, respectively) according to the present invention is a containment designed to carry a support module (10, 20 and 30, respectively). Such containment preferably contains a rigid frame (26) to which the support module is removably fixed. The dimension of the frame is preferably designed to have dimensions such that the module can be contained in full, so that no parts extend to the area outside the frame. In preferable embodiments, the carrier elements have a cuboid outer form and are made up by flanges or posts (24) connected firmly at the corners and rigidified by diagonal crosses (25). Such container has supports for receiving the support module. Preferably, the carrier element further contains means to move the carrier element from one location to another. Preferably, the container has rollers (22) for moving the carrier element on the ground during transport. Preferably, the container further has pillars (23) for final placement of the carrier. In a most preferred embodiment, the rollers can be raised from the surface to depose the carrier element to the ground on the pillars and thus firmly position the carrier element on ground. In this way, the carrier element is in its final placement position.

Furthermore, each carrier element may contain means to join to adjacent carrier elements firmly. This connection can be made through holes and pins of adjacent carrier elements. Then, one of the carrier elements has one or more holes and/or pins, which fit to pins and/or holes of the adjacent carrier element, respectively. Alternatively, the pins are affixed to the frame using a fixation bar (52) bearing a pin at a location that can access and engage to a hole of an adjacent carrier element. In this way, standardized frames can be used to construd all carrier elements used in the assembly. If needed, the carrier elements can further be linked together using screws, nuts and bolts, preferably after fixation using holes and pins as described above.

Preferably, at least two of the carrier elements comprise carrier spots designed to support the transfer module using corresponding elements on said transfer module. Those carrier elements should be made from a resistive material appropriately to account for the weight of the transfer module. More preferably, the carrier spots include means to firmly connect or lock the transfer module to the carrier element, such that the transfer module cannot disengage from the carrier element, for instance by screws.

One or more support modules (10, 20, and 30) are provided on a support (21) of said carrier element, preferably such that the support modules can be released from the frame when the carrier elements are in final position, in order to connect the support modules to the transfer module. Preferably, during transportation, the support modules are preferentially firmly fixed to the carrier element. Prior to assembly of the modular apparatus, such firm fixation is unfastened, thus releasing the support module from said firm fixation, while the frame of the carrier still supports the support module via the supports. In a preferred embodiment, the supports are compressible. Compressibility can be realized by springs or gum. More preferably, the support is compressible to such extend, that by its weight, the support module squeezes the support down to a position leaving more room to squeeze the compressible support, when the transfer module is placed above the support module, thus further squeezing down the compressible support. In the final position, the support modules will preferably be held by the supports such that they contact the transfer module and can be firmly connected to the transfer module.

The modular apparatus of the present invention is preferably designed to conduct the multi-step analytical process for between 4 and 96, more preferable between 8 and 24, samples in an essentially parallel manner. More preferable, the analysis is done such that each sample is treated in a separate vessel. This has particular advantages for multi-step analytical processes, as needed in fully automated nucleic acid detection processes comprising sample preparation, amplification and detection on one instrument. Such multi-step analytical processes make attractive the use of different modules, each having different functions. Furthermore, the different functions require extended and heavy components. Such apparatuses are difficult to transport due to their weight and dimensions. The modular apparatus of the present invention has the advantage that it can be assembled at the final destination using a particularly advantageous method for manufacture.

The apparatus according to the invention contains two or more, preferably three or more support modules, most preferably 3 support modules. Those support modules can be located in relation to the transfer heads at different distances. FIG. 4 shows an embodiment, where the support modules have different heights. Furthermore, the items located on the support module, for instance racks, vessels, pipette tips and others, may be located at different distances from the transfer heads. It may readily be understood that different items may require different mechanisms and thus heights of the handling position. Operating such apparatus is accomplished in a convenient manner according to the invention.

Therefore, another subject of the present invention is a method for assembling an apparatus for conducting a multi-step analytical process comprising a transfer module, at least two support modules firmly fixed to said transfer module and at least two carrier elements comprising providing at least two support modules flexibly fixed to said carrier elements, providing said transfer module and placing it onto said carrier elements, connecting the transfer module to said carrier elements and firmly fixing said support modules to said transfer module.

In FIGS. 2 a to 2 g, an exemplary method for assembly of a modular apparatus is shown. While it is preferred that the assembly is done at the place of final destination of the instrument, the assembly can also be done at the site of manufacture, and the instrument in-toto be transported to its final destination, for instance, if there is enough space on the transport path. The advantages of easy adjustment of the apparatus are applicable in this embodiment, too.

In a first step (shown in FIG. 2 a, left hand side), a first carrier element (B) is provided. It can be moved on rollers (22; only one of the rollers is marked for better reading of the figures) to any desired position in the laboratory in which the modular apparatus should be operated. The carrier element (B) is positioned at the desired location (FIG. 2a, right hand side) by raising the rollers (22) such that the carrier element is born by the pillars (23; only one of the pillars is marked for better reading of the figures). Support module 20 is only shown as a plate to reduce complexity of the drawing. In reality, support module 20 may extend both upwards and downwards from the plate as shown. The support module is borne by compressible supports (21; only one of the supports is marked for better reading of the figures). The carrier element comprises a frame (26), containing posts (24) rigidified by a crossing (25). A level (51) can be provided to level the final horizontal placement.

FIG. 2 b shows a second carrier element (A) carrying a different support module (10) on its rollers. A fixation bar (52) carrying a pin is attached to the carrier element A in a first step.

FIG. 2 c shows how two carrier elements (A) and (C), each carrying a pin, are approached to carrier element B such that the pins fit into holes of carrier element B on rollers. Carrier element C carries a third support module (30).

FIG. 2 d shows the final assembly of carrier elements A, B and C, wherein all rollers were raised, and the pins on carrier elements A and C are locked into holes of carrier element B, such that the assembly is located on pillars of each of carrier elements A, B and C. The assembly is adjusted to be even using double levels, particularly in Y-direction, such that the carrier elements are not distorted against each other. In this way, the carrier elements are roughly adjusted. Furthermore, it is possible to adjust the position of said compressible support on said carrier elements in Z-direction to adjust the final position of said transfer module prior to placing said transfer module onto said carrier elements. The adjustment of the carrier elements can also be done after placement of the transfer module.

In the next step, shown in FIG. 2 e, the transfer module (40) is placed onto supports on three carrier elements. Those supports are called carrier spots in the following. Preferably, those carrier spots are placed at the outer corners of the outermost carrier elements. Most preferably, the transfer module is placed on three or four carrier spots, to allow fixation of the transfer module relative to the carrier elements. At this stage, another adjustment of the carrier elements can be done.

FIG. 2f shows a preferred embodiment of arrangement of carrier spots. The carrier spots preferably are one flat bearing (A1, C1) and two pins (A2, C2). The counterparts on the transfer module are flat bearings, a hole and a long hole. The bearing of the transfer is designed according to a tetrahedron-vee-flat coupling (see Precision Engeneering 25 (2001) 114-127). The entirety of which is hereby incorporated by reference. It will be understood, that the counterparts on the transfer module and the carrier module can be used vice versa.

Finally, the transfer module essentially covers the part of the carrier elements that include a working area of any support module. Thus, the support modules are connected to the bottom of said transfer module.

The geometry of the supports (21) for carrying the support modules (10, 20 and 30), the integral engagement elements (53, 54) and the carrier spots (A1, A2, C1, C2) are shown in FIG. 2 f. Preferably, the transfer module is additionally fixed to the carrier elements A and C by screws through carrier spots A1, A2, C1 and C2. At this point in time, the support modules (10, 20, 30) are each located at a short distance below the transfer module or anchors attached thereto.

In the next step, the support modules (10, 20, and 30) are firmly connected to the transfer module. This is preferably done by attaching the support modules to the transfer module, preferably using anchors, on the bottom of the transfer module, for example by bolts. In order to achieve this, it is preferred that the distance between the support modules and the anchors in the transfer module is very short. Most preferred, the integral engagement elements are already located at their final position when the transfer module has been placed upon the carrier element assembly. This can be achieved by using compressible supports on the carrier elements that together with the support module placed thereon are further depressed when placing the transfer module onto the assembly. The supports can be pre-adjusted prior to placing the transfer module, for instance by changing the spring length or form. Most preferably, the support modules are buoyantly supported. In this case, the support modules are located on said carrier elements such that when the transfer module is placed on said carrier elements, said support modules touch the anchors of the transfer module and can easily be connected therewith. Thus, a preferred embodiment of the invention is the attachment of the support modules to the transfer module from underneath. To illustrate this further, the support modules would be hanging from the transfer module, if there would not be the support from the compressible supports of the carrier elements.

After the transfer module has been added, additional modules can be added, for example a cover (55) or further equipments. If desired, the whole assembly can be further fixed. The final apparatus is shown in FIG. 2g.

In FIG. 3 there is schematically shown a transfer module 40 with a transfer head 44 mounted on a transfer arm (42) movable on rails 41 and 43. Thus, the handling units are moveable in the three dimensions X, Y, and Z. The head can access three different working areas (represented by support modules 10, 20 and 30), each having a different dimension, i.e. height and length.

The apparatus of the present invention is characterized by the fact, that the elements which are most sensitive to exact positioning during assembly of the complete apparatus are already in a pre-assembled status, while the modules, the tools of the transfer module interact with and which have a heavy weight, can be attached to the transfer unit in a very convenient and exact manner, even on uneven ground. Furthermore, it is not necessary that the working areas of these different support modules are located on a common plane. This is achieved by using a transfer module the tools on which can freely move in all three spatial directions (X, Y, Z), for instance a transfer head. The present invention also improves the situation, wherein the tools of the transfer module may have changed their form during use, as it provides more preciseness from the start.

In order to further improve exact access of the transfer head(s) to the items located on the working areas, the transfer head(s) can additionally be calibrated in a relative manner. This is preferably done by defining at least one calibration position on each working area which can be recognized by the transfer head. This can be achieved by appropriate sensing means, for instance, using laser sensors. The calibration position is used as a reference point for defining the other positions in the same working area accessed by the transfer head(s), for example positions where vessels are located, or sample input or output positions. The use of shorter distances between calibration positions and operation positions makes the process even more precise.

Another subject of the invention is a method for analysis of a component in a sample using an apparatus according to the present invention. This method particularly comprises placing the sample on a first working area of a first support module of said apparatus, transferring the sample or a liquid derived therefrom to a working area of a second support module using a tool of a transfer module of said apparatus, and analyzing the sample or a liquid derived therefrom on a working area of said second or a third support module.

While the forgoing invention has been described in some detail for the purposes of clarity and understanding, it would be clear to one skilled in the art from reading the instant disclosure that various changes in form and detail may be made without departure from the scope of the invention. All publications, patents, patent applications, web pages and other documents cited herein are incorporated by reference in their entirety for all purposes.

What is claimed is:

1. An apparatus for conducting a multi-step analytical process comprising:
a). a transfer module effective to transfer items from one position on the apparatus to another position on the apparatus,
b). at least two support modules firmly connected to the bottom of said transfer module, said support modules comprising tools adapted to hold the items to be subject to analysis in one or more predetermined positions, and any other further comprising apparatus effective to perform said analysis,
c). at least two carrier elements firmly connected to said transfer module effective to releasably carry said support modules and bearing said transfer module,
wherein said support modules and said transfer module comprise corresponding integral engagement elements to exactly position said support modules in relation to said transfer module.

2. The apparatus according to claim 1, wherein said transfer module is supported by said carrier elements at either 3 or 4 carrier spots.

3. The apparatus of claim 1 having a length of at least 1.00 meter.

4. The apparatus according to claim 1, wherein said transfer module comprises a mechanical unit capable of moving from a first position of said support modules to a second position of said support modules.

5. The apparatus of claim 1, wherein said transfer module comprises a mechanical unit for transporting items from a first position of said support modules to a second position of said support modules.

6. The apparatus of claim 1, wherein said mechanical unit is composed of at least two individual transport heads mounted for horizontal movement on a rail reaching from said first to said second support module.

7. The apparatus of claim 1, wherein at least one of said support modules is a module providing containers for the analytical process.

8. The apparatus of claim 1, wherein at least one of said support modules is a module for separation of an analyte from a sample using a container.

9. The apparatus of claim 8, characterized in that a further support module is a module for determining electromagnetic signals.

10. The apparatus of claim 1, wherein the weight of each of said first and second support modules is more than 10 kilograms.

11. The apparatus of 1, wherein the length of said carrier modules is at least 0.5 meters.

12. A method for assembling an analytical apparatus for an analytical process comprising:
a). a transfer module designed to transfer items from one position on the apparatus to another position on the apparatus,
b). at least two support modules firmly connected to said transfer module, said support modules comprising tools adapted to keep the items to be subject to analysis and any means needed for the analysis, and
c). at least two carrier elements firmly connected to said transfer module and bearing said transfer module, comprising the steps of:
d). providing at least two support modules releasably fixed to said carrier elements,
e). providing said transfer module and placing it onto said carrier elements,
f). firmly connecting said support modules to said transfer module.

13. The method of claim 12, wherein said support modules are provided on compressible supports on said carrier elements.

14. The method of claim 12 further comprising adjusting the position of at least one carrier spot on said carrier elements in a Z-direction to adjust the final position of said transfer module prior to placing said transfer module onto said carrier elements.

15. The method of claim 13 further comprising adjusting the position of said compressible support on said carrier elements in Z-direction to adjust the final position of said transfer module prior to placing said transfer module onto said carrier elements.

16. A collection of modules for assembling an analytical apparatus according to claim 1 comprising:
a). a transfer module,
b). at least two carrier elements capable of being connected to said transfer module and
c). at least two support modules releasably fixed to said carrier elements, said support modules comprising tools adapted to hold the items to be subject to analysis in one or more predetermined positions, and further comprising one or more apparatus effective to perform said analysis, wherein said support modules and said transfer module comprise integral engagement elements to position said support modules in a predetermined relation to said transfer module.

17. A collection of modules for manufacturing an analytical apparatus according to claim 1 for an analytical process comprising:
a). a the transfer module,
b). at least two carrier elements capable of being connected to said transfer module and,
c). at least two support modules releasably held to said carrier elements, said support modules comprising tools adapted to the items to be subject to analysis in one or more predetermined positions and any means needed for the analysis, and further comprising one or more apparatus effective to perform said analysis, wherein said support modules and said transfer module comprise integral engagement elements to position said support modules in a predetermined relation to said transfer module.
characterized wherein said support modules are provided on compressible supports on said carrier elements.
